(19) United States
(12) Patent Application Publication
(10) Pub. No.: US 2018/0041257 A1
(43) Pub. Date: Feb. 8, 2018

(54) MANAGEMENT OF TWO OR MORE NODES WITH A COMMON COMMUNICATION OBJECTIVE

(71) Applicant: QUALCOMM Incorporated, San Diego, CA (US)

(72) Inventors: Wanshi CHEN, San Diego, CA (US); Shimman Arvind PATEL, San Diego, CA (US); Hao XU, Beijing (CN)

(21) Appl. No.: 15/660,493

(22) Filed: Jul. 26, 2017

Related U.S. Application Data
(60) Provisional application No. 62/371,299, filed on Aug. 5, 2016.

(51) Int. Cl. H04B 7/024

(52) U.S. Cl. CPC H04B 7/024

(57) ABSTRACT

Certain aspects of the present disclosure relate to methods and apparatus for managing common communication objectives of two or more wireless nodes. For example, certain aspects provide a method for wireless communication by a first wireless node. The method may generally include determining a configuration for communicating information associated with a common communication objective shared with at least one second wireless node, and communicating the information with a destination node based on the configuration.

### CROSS-REFERENCE TO RELATED APPLICATIONS

This application claims benefit of priority to provisional application No. 62/371,299, filed Aug. 5, 2016, which is expressly incorporated herein by reference in its entirety.

### BACKGROUND

### Field of the Disclosure

The present disclosure relates generally to wireless communication, and more particularly, to methods and apparatus for managements of nodes.

### Description of Related Art

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE/LTE-Advanced is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “DETAILED DESCRIPTION” one will understand how the features of this disclosure provide advantages that include improved communications between access points and stations in a wireless network.

The present disclosure relates generally to wireless communication, and more particularly, to design principles for managing communication of information associated with a common communication objective of multiple wireless nodes.

Certain aspects of the present disclosure provide a method for wireless communications by a first wireless node. The method generally includes determining a configuration for communicating information associated with a common communication objective shared with at least one second wireless node, and communicating the information with a destination node based on the configuration.

Certain aspects of the present disclosure provide a method for wireless communications by a destination node. The method generally includes determining a configuration for communicating information associated with a common communication objective shared by a plurality of wireless nodes, and communicating the information with at least one of the plurality of wireless nodes based on the configuration.

Certain aspects of the present disclosure provide an apparatus for wireless communication by a first wireless node. The apparatus may generally includes at least one antenna, a processing system configured to determine a configuration for communicating information associated with a common communication objective shared with at least one second wireless node, and communicate, via the at least one antenna, the information with a destination node based on the configuration.

Certain aspects of the present disclosure provide an apparatus for wireless communication by a destination node. The apparatus generally includes at least one antenna, and a processing system configured to determine a configuration for communicating information associated with a common communication objective shared by a plurality of wireless nodes, and communicate, via the at least one antenna, the information with at least one of the plurality of wireless nodes based on the configuration.

Certain aspects of the present disclosure provide a computer-readable medium having instructions stored thereon to cause a first wireless node to determine a configuration for communicating information associated with a common communication objective shared with at least one second wireless node, and communicate the information with a destination node based on the configuration.

Certain aspects of the present disclosure provide a computer-readable medium having instructions stored thereon to cause a destination node to determine a configuration for communicating information associated with a common communication objective shared by a plurality of wireless nodes, and communicate the information with at least one of the plurality of wireless nodes based on the configuration.

Certain aspects of the present disclosure provide an apparatus for wireless communication by a first wireless node. The apparatus generally includes means for determining a configuration for communicating information associated with a common communication objective shared with at least one second wireless node, and means for communicating the information with a destination node based on the configuration.

Certain aspects of the present disclosure provide an apparatus for wireless communication by a destination node. The apparatus generally includes means for determining a configuration for communicating information associated with a common communication objective shared by a plurality of wireless nodes, and means for communicating the information with at least one of the plurality of wireless nodes based on the configuration.

Other aspects, features, and embodiments of the present disclosure will become apparent to those of ordinary skill in the art, upon reviewing the following description of specific, exemplary aspects of the present disclosure in conjunction with the accompanying figures. While features of the present disclosure may be discussed relative to certain aspects and figures below, all aspects of the present disclosure can include one or more of the advantageous features discussed herein. In other words, while one or more aspects may be discussed as having certain advantageous features, one or more of such features may also be used in accordance with the various aspects of the present disclosure. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. The appended drawings illustrate only certain typical aspects of this disclosure, however, and are therefore not to be considered limiting of its scope, for the description may admit to other equally effective aspects.

FIG. 1 is a diagram illustrating an example of a network architecture.

FIG. 2 is a diagram illustrating an example of an access network.

FIG. 3 illustrates an example deployment of narrowband internet-of-things (NB-IoT), according to certain aspects of the present disclosure.

FIG. 4 illustrates an example wireless communication system, in accordance with certain aspects of the present disclosure.

FIG. 5 illustrates example operations for wireless communication by a destination node receiving an indication of a common communication objective, in accordance with certain aspects of the present disclosure.

FIG. 6 illustrates example operation for wireless communication by a wireless node, in accordance with certain aspects of the present disclosure.

FIG. 7 illustrates example operation for wireless communication by a destination node, in accordance with certain aspects of the present disclosure.

FIG. 8 is a diagram illustrating an example of an evolved Node B and user equipment in an access network, in accordance with certain aspects of the disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Narrow-Band IoT (NB-IoT) is a technology being standardized by the 3GPP standards body. This technology is a narrowband radio technology specially designed for the IoT. Special focuses of this standard include indoor coverage, low cost, long battery life and large number of devices. The NB-IoT technology may be deployed “in-band,” utilizing resource blocks within, for example, a normal long term evolution (LTE) spectrum or Global System for Mobile communications (GSM) spectrum. In addition, NB-IoT may be deployed in the unused resource blocks within a LTE carrier's guard-band, or “standalone” for deployments in dedicated spectrum.

Machine type communications (MTC) and/or enhanced MTC (eMTC) may refer to communication involving at least one remote device on at least one end of the communication and may include forms of data communication which involve one or more entities that do not necessarily need human interaction. MTC devices may include devices that are capable of MTC and/or eMTC communications with MTC servers and/or other MTC devices through Public Land Mobile Networks (PLMN), for example.

Both eMTC and NB-IoT may be designed to increase cell coverage. This may be achieved via time-domain bundling of DL or UL transmissions. For example, one transport block (TB) can be transmitted repeatedly using as many as thousands of subframes. The bundling may be performed for both broadcast and unicast transmissions. Moreover, the repetition level for a channel is generally indicated by broadcast of system information, but can be further indicated or modified on a per user-equipment (UE) basis. For example, different repetition levels may be indicated for different channels.

In some cases, it may be likely that multiple wireless nodes (e.g., IoT devices) share the same communication objective. For example, two or more wireless nodes may be sensing the same object, measuring the same object (e.g., for increased reliability), and/or having the same information to be conveyed to a destination node (e.g., base station). Thus, if a wireless node fails to communicate information associated with a common communication objective, other wireless nodes having the same communication objective may communicate the information. Certain aspects of the present disclosure are generally directed to apparatus and techniques for managing the communication objectives of the two or more nodes in an efficient and effective manner.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2). These communications networks are merely listed as examples of networks in which the techniques described in this disclosure may be applied; however, this disclosure is not limited to the above-described communications network.

Single carrier frequency division multiple access (SC-FDMA) is a transmission technique that utilizes single carrier modulation at a transmitter side and frequency domain equalization at a receiver side. The SC-FDMA has similar performance and essentially the same overall complexity as those of OFDMA system. However, SC-FDMA signal has lower peak-to-average power ratio (PAPR) because of its inherent single carrier structure. The SC-FDMA has drawn attention, especially in the uplink (UL) communications where lower PAPR greatly benefits the wireless node in terms of transmit power efficiency.

An access point (“AP”) may comprise, be implemented as, or known as NodeB, Radio Network Controller (“RNC”), eNodeB (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or be known as an access terminal, a subscriber station, a subscriber unit, a mobile station, a remote station, a remote terminal, a user terminal, a user agent, a user device, user equipment (UE), a user station, a wireless node, or some other terminology. In some implementations, an access terminal may comprise a cellular telephone, a smart phone, a cordless telephone, a Session Initiation Protocol (“SIP”) phone, a wireless local loop (“WLL”) station, a personal digital assistant (“PDA”), a tablet, a netbook, a smartbook, an ultrabook, a handheld device having wireless connection capability, a Station (“STA”), or some other suitable processing device connected to a wireless modem. Accordingly, one or more aspects taught herein may be incorporated into a phone (e.g., a cellular phone, a smart phone), a computer (e.g., a desktop), a portable communication device, a portable computing device (e.g., a laptop, a personal data assistant, a tablet, a netbook, a smartbook, an ultrabook), wearable device (e.g., smart watch, smart glasses, smart bracelet, smart wristband, smart ring, smart clothing, etc.), medical devices or equipment, biometric sensors/devices, an entertainment device (e.g., music device, video device, satellite radio, gaming device, etc.), a vehicular component or sensor, smart meters/sensors, industrial manufacturing equipment, a global positioning system device, or any other suitable device that is configured to communicate via a wireless or wired medium. In some aspects, the node is a wireless node. A wireless node may provide, for example, connectivity for or to a network (e.g., a wide area network such as the Internet or a cellular network) via a wired or wireless communication link. Some UEs may be considered machine-type communication (MTC) UEs, which may include remote devices, that may communicate with a base station, another remote device, or some other entity. Machine type communications (MTC) may refer to communication involving at least one remote device on at least one end of the communication and may include forms of data communication which involve one or more entities that do not necessarily need human interaction. MTC UEs may include UEs that are capable of MTC communications with MTC servers and/or other MTC devices through Public Land Mobile Networks (PLMN), for example. Examples of MTC devices include sensors, meters, location tags, monitors, drones, robots/robotic devices, etc. MTC UEs, as well as other types of UEs, may be implemented as NB-IoT (narrowband internet of things) devices.

### Example Wireless Communications System

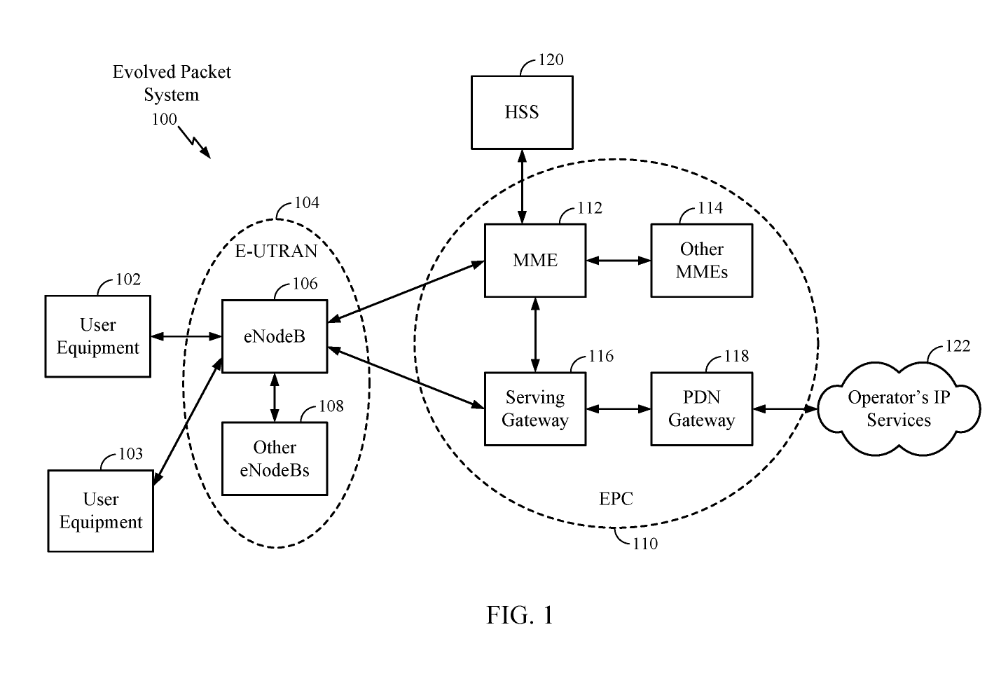

FIG. 1 is a diagram illustrating an LTE network architecture 100 in which aspects of the present disclosure may be practiced. For example UE 102 may receive an uplink grant from an eNB 106 or 108 indicating one or more resource elements within a resource block (RB) allocated to the UE for narrowband communication. The UE 102 may then transmit using the one or more resource elements indicated in the uplink grant.

The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. Exemplary other access networks may include an IP Multimedia Subsystem (IMS) PDN, Internet PDN, Administrative PDN (e.g., Provisioning PDN), carrier-specific PDN, operator-specific PDN, and/or GPS PDN. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), an access point, or some other suitable terminology. The eNB 106 may provide an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a netbook, a smart book, an ultrabook, a drone, a robot, a sensor, a monitor, a meter, a camera/security camera, a gaming device, a wearable device (e.g., smart watch, smart glasses, smart ring, smart bracelet, smart wrist band, smart jewelry, smart clothing, etc.), any other similar functioning device, etc. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include, for example, the Internet, the Intranet, an IP Multimedia Subsystem (IMS), and a PS (packet-switched) Streaming Service (PSS). In this manner, the UE 102 may be coupled to the PDN through the LTE network.

In certain aspects the eNB 106 may serve multiple UEs 102 and 103. In some instances, UEs 102 and 103 may be NB-IOT or eMTC devices and may share the same communication objective. For example, the UEs 102 and 103 may both be sensors sensing/measuring the same object, or may have the same information to convey to another node. Given the shared communication objective, various communication configurations can be used to improve communication efficiency and effectiveness. For example, if the UE 102 fails to communicate information associated with the common communication objective, UE 103 may communicate the information instead. Certain aspects of the present disclosure are generally directed to apparatus and techniques for managing the communication objectives of two or more nodes (e.g., UEs 102 and 103) in an efficient and effective manner.

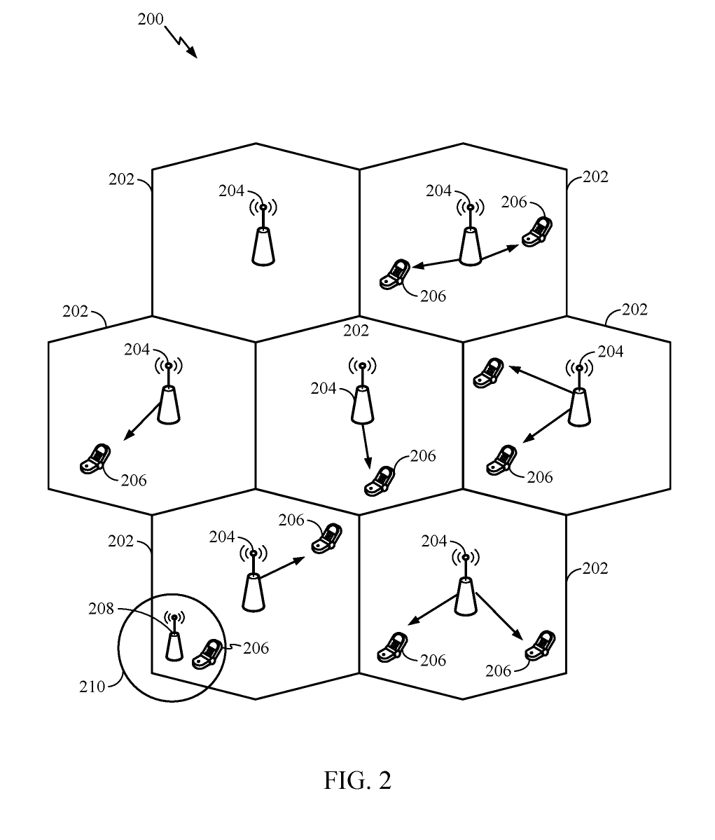

FIG. 2 is a diagram illustrating an example of an access network 200 in an LTE network architecture in which aspects of the present disclosure may be practiced. For example, UEs 206 and eNBs 204 may be configured to implement techniques for implementing a new transmission scheme for NB-IoT or eMTC operation described in aspects of the present disclosure.

In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. The network 200 may also include one or more relays (not shown). According to one application, a UE may serve as a relay.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network may be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

As described in further detail below, in some instances, UE 206 may be an NB-IoT or eMTC device, and multiple ones of the UEs 206 may be served by the same eNB 204. In some cases, the UEs 206 may share the same communication need, especially UEs within proximity of one another in NB-IOT operation. For example, two UEs 206 may both be sensors sensing/measuring the same object, or may have the same information to convey to another node (e.g., another UE 206 or eNB 204). Accordingly, the two UEs 206 may share a common communication objective.

Given the shared communication objective, various communication configurations can be used to improve communication efficiency and effectiveness. In particular, different communication configurations may be selected that allow varying degrees of cooperation between or among UEs 206 sharing a common communication objective. For example, in a joint (cooperative) communication configuration, a plurality of UEs 206 may communicate information associated with the common communication objective with the eNB 204, while in a single (non-cooperative) communication configuration, a single UE 206 may communicate the information with the eNB 204. In some instances, the eNB 204 may select the communication configuration, while in other instances, one or more UEs 206 may select the communication configuration. The selection process may be based on various factors as will be described in further detail herein.

In certain aspects, the UEs 206 may be NB-IoT or eMTC devices. The Internet-of-Things (IoT) is a network of physical objects or “things” embedded with, for example, electronics, software, sensors, and network connectivity, which enable these objects to collect and exchange data. IoT allows objects to be sensed and controlled remotely across existing network infrastructure, creating opportunities for more direct integration between the physical world and computer-based systems, and resulting in improved efficiency, accuracy and economic benefit. When IoT is augmented with sensors and actuators, the technology becomes an instance of the more general class of cyber-physical systems, which also encompasses technologies such as smart grids, smart homes, intelligent transportation and smart cities. Each “thing” is generally uniquely identifiable through its embedded computing system but is able to interoperate within the existing Internet infrastructure.

MTC and/or eMTC may refer to communication involving at least one remote device on at least one end of the communication and may include forms of data communication which involve one or more entities that do not necessarily need human interaction. MTC devices may include devices that are capable of MTC and/or eMTC communications with MTC servers and/or other MTC devices through Public Land Mobile Networks (PLMN), for example. NB-IoT is a narrowband radio technology specially designed for the IoT, which may have a special focus on indoor coverage, low cost, long battery life and large number of devices.

MTC/eMTC and NB-IoT devices may be low cost. For example, MTC/eMTC may be implemented using one antenna, half-duplex (HD), narrowband (1.08 MHz), and with small transport block (TB) size (1,000 bits). Data on a transport channel may be organized into transport blocks. In each transmission time interval (TTI), a single transport block of a dynamic size may be transmitted over the radio interface to/from a terminal in the absence of spatial multiplexing. In the case of spatial multiplexing (MIMO), there can be up to two transport blocks per TTI. Moreover, MTC/eMTC may have a simplified operation by using a limited number of transmission modes (TM), and limited feedback. MTC/eMTC may be low power by including a power save mode (PSM) and extended discontinuous reception (eDRX). NB-IoT may operate in a narrow band of 180 kHz, with new primary synchronization sequence (PSS), secondary synchronization sequence (SSS), physical broadcast channel (PBCH), physical random access channel (PRACH), physical downlink shared channel (PDSCH), and physical uplink shared channel (PUSCH), and may have a single tone uplink (UL). NB-IoT may have extended coverage by use of transmission time interval (TTI) bundling, and have a simplified communication protocol.

A new air interface is being introduced for 5G, including features that include Enhanced mobile broadband (eMBB) targeting wide bandwidth (e.g. 80 MHz beyond), millimeter wave (mmW) targeting high carrier frequency (e.g. 60 GHz), massive MTC (mMTC) targeting non-backward compatible MTC techniques, and mission critical targeting ultra-reliable low latency communications (URLLC). For these general topics, different techniques are considered, such as coding, low-density parity check (LDPC), and polar.

NB-IoT and eMTC are being deployed today by network operators around the world. The intended operations last for several years for some devices, such as for meter devices deployed in basements, or sensing devices buried underground. It may be desirable to allow co-existence of 5G and NB-IoT/eMTC.

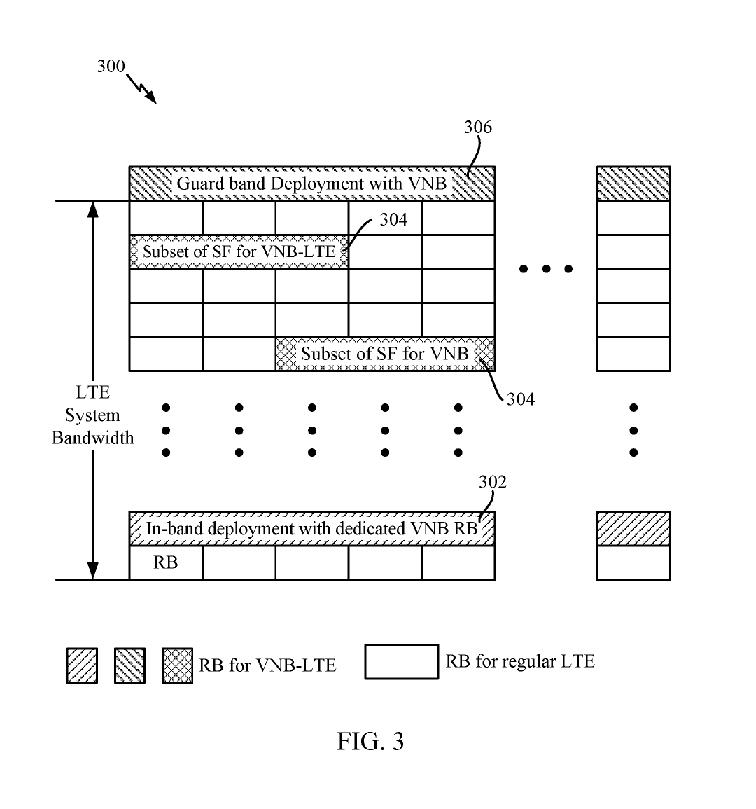

FIG. 3 illustrates an example deployment 300 of NB-IoT, according to certain aspects of the present disclosure. According to certain aspects, NB-IoT may be deployed in three broad configurations, which may be used to communicate information associated with a common communication objective between multiple wireless nodes as will be described in more detail herein. In certain deployments, NB-IoT may be deployed in-band and coexist with legacy GSM/WCDMA/LTE system(s) deployed in the same frequency band. Wideband LTE channel, for example, may be deployed in various bandwidths between 1.4 MHz to 20 MHz, and there may be a dedicated RB 302 available for use by NB-IoT, or the RBs allocated for NB-IoT may be dynamically allocated 304 throughout the system bandwidth in various locations as a subset of the subframe, as seen in FIG. 3. In an in-band deployment, one resource block (RB) of a wideband LTE channel may be used for NB-IoT. LTE implementations may include unused portions of radio spectrum between carriers to guard against interference between adjacent carriers. In some deployments, NB-IoT may be deployed in a guard band 306 of the wideband LTE channel. In other deployments, NB-IoT may be deployed standalone (not shown). In a standalone deployment, one carrier may be utilized to carry NB-IoT traffic and GSM spectrum may be reused.

Both eMTC and NB-IoT may be implemented with narrow bandwidths. For example, eMTC may be implemented with 6 RBs or 1.08 MHz and NB-IoT may be implemented with 1 RB or 180 kHz. Both eMTC and NB-IoT may be implemented with half-duplex operation. For example, switching from downlink (DL) to uplink (UL) (or UL to DL) in FDD can take as long as 1 ms. Switching from one DL (or UL) narrowband to another DL (or UL) narrowband, or from DL to UL, can take less time, e.g., two symbols, in TDD as compared to FDD. Both eMTC and NB-IoT can be operated with regular long term evolution (LTE) UEs in the same cell (e.g., in-band deployment). For example, an LTE call may serve both smart phone UEs and low cost UEs in a same subframe, e.g., via frequency-divisional multiplexing (FDM). As described previously, NB-IoT can be deployed in guard-bands, or in standalone mode.

As presented above, both eMTC and NB-IoT may be designed to increase cell coverage. This may be achieved via time-domain bundling of DL or UL transmissions. For example, one TB can be transmitted repeatedly using as many as thousands of subframes.

In some cases, frequency hopping may be enabled for a TB transmission involving a large number of subframes in order to further enhance frequency diversity. That is, the TB may be transmitted in a narrowband for Y_{ch} subframes, before hopping to a different narrowband for other Y_{ch} subframes. For example, for eMTC, where a UE may be configured with coverage enhancement (CE) modes A or B, the following values may be defined for Y_{ch}:

CE mode A: FDD: Y_{ch}=11, 2, 4, 81, TDD: Y_{ch}={1, 5, 10, 20}
CE mode B: FDD: Y_{ch}={2, 4, 8, 16}, TDD: Y_{ch}={5, 10, 20, 40}
These values may be specifically designed for each CE mode and each system type (FDD vs. TDD). An eMTC/IoT UE may also be indicated a set of subframes that are valid for DL (or UL) transmissions. In other words, not all subframes may be valid for eMTC/IoT transmissions. In some cases, staying on a first narrowband for a while before jumping to another narrowband allows for better channel estimation on the first narrowband.

### Example Techniques for Management of Two or More Nodes with a Common Communication Need

As presented above, it may be likely that multiple wireless nodes (e.g., NB-IoT or eMTC devices) share the same communication objective. Certain aspects of the present disclosure are generally directed to apparatus and techniques for managing the communication objectives of two or more nodes in an efficient and effective manner.

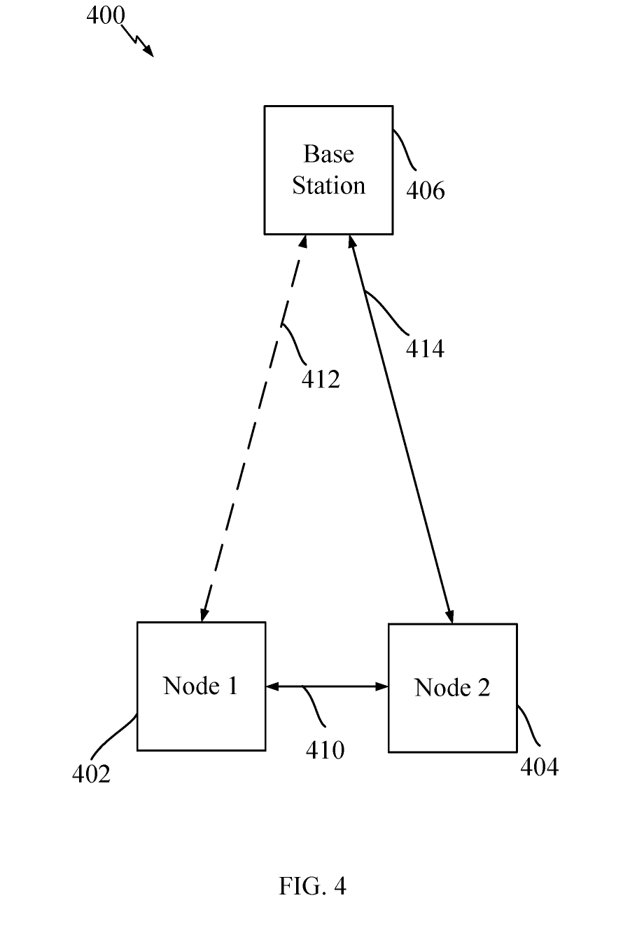

FIG. 4 illustrates an example communication system 400, in accordance with certain aspects of the present disclosure. As illustrated, the communication system 400 may include a plurality of wireless nodes such as wireless node 402 and wireless node 404. The wireless nodes 402 and 404 may share a common communication objective as described above. While aspects of the present disclosure may be described with respect to two wireless nodes 402 and 404 to facilitate understanding, the techniques described herein may be applied to any number of wireless nodes that share a common communication objective or have a partial overlap of their communication objectives. In some cases, the association of the common communication objective may be established by the wireless nodes 402 and 404 via device-to-device communications, as represented by line 410, or by other means such as via programming or via an association with a particular task.

In certain aspects, the wireless nodes 402 and 404 may be configured with the same radio network temporary identifier (RNTI). In other aspects, the wireless nodes 402 and 404 may be associated with different RNTIs by the destination node. For example, one or more bits (e.g., least significant bits) of the RNTI may be used to differentiate between the wireless nodes 402 and 404. As another example, a same RNTI may be assigned to a group of wireless nodes, while each of the nodes in the group of wireless nodes may be additionally assigned a sub-RNTI to differentiate the wireless nodes within the group.

In certain aspects, the determination of the configuration may be determined by the wireless nodes 402 and 404, but may be selected by the destination node 406 in some aspects. For example, the wireless nodes 402 and/or 404 may send an indication to the destination node 406 (e.g., a base station) of the common communication objective and the destination node 406 may determine the communication configuration based on the objective and send an indication of the configuration to the wireless nodes 402 and 404. The wireless nodes 402 and 404 may then determine the configuration based on the indication received from the destination node 406.

In certain aspects, the association of the common communication objective may be identified based on an opportunistic assistance from the wireless node (e.g., wireless node 404). For example, the wireless node 404 may have the opportunity to assist wireless node 402 in the communication of information associated with the communication objective as determined based on one or more factors. These factors may include power limitations of the wireless node 404, location of the wireless node 404 (e.g., with respect to the destination node 406), a condition of a channel used to communicate information with the destination node 406, or traffic conditions on the channel. For example, certain wireless nodes (e.g., wireless node 404) may not be battery powered or battery consumption may not be a primary design goal for the wireless node (e.g., in home or in vehicle appliances). Some wireless nodes may be power-limited, and thus, power consumption may be one of the primary design targets (e.g., battery-powered power metering or battery-power sensors). In some cases, wireless nodes 402 and 404 may have different levels of power constraints. For example, wireless node 402 may have less power remaining as compared to wireless node 404 or wireless node 404 may be equipped with larger battery power capacity than wireless node 402.

In some cases, the wireless nodes 402 and 404 may be physically close to each other. As a result, the wireless nodes 402 and 404 may be closely coordinated without much power/overhead cost. Certain aspects of the present disclosure may use cooperative communication (e.g., multi-layer transmissions via the two or more wireless nodes, dynamic node switching) to improve link efficiency by taking into account one or more of these factors. In some examples, cooperative communication by the wireless nodes may improve link efficiency.

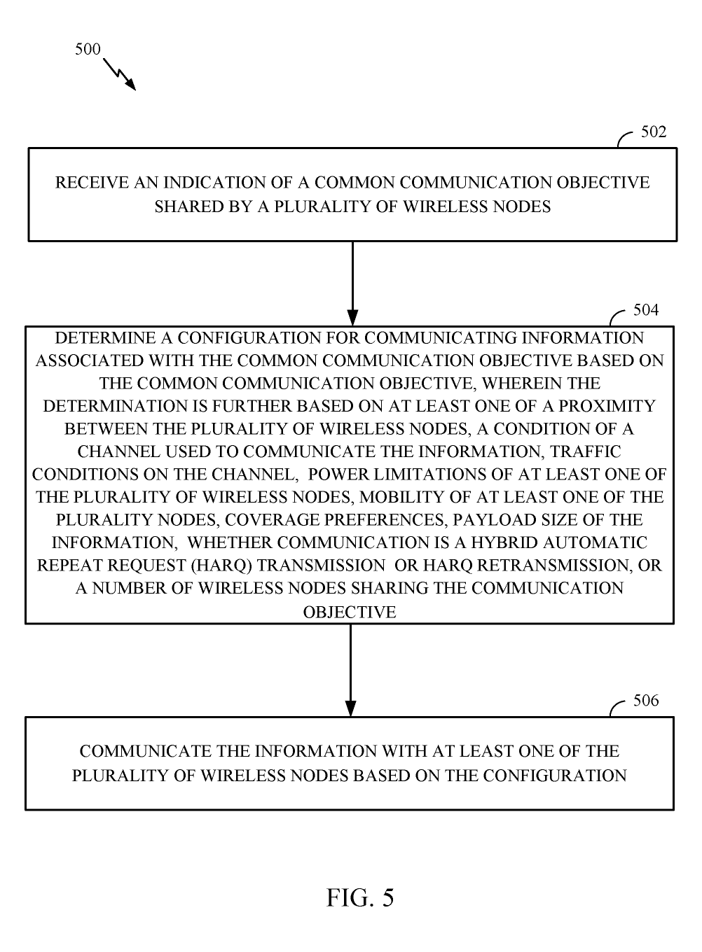

FIG. 5 illustrates example operations 500 for wireless communication by the destination node, in accordance with certain aspects of the present disclosure. The operations 500 may begin, at block 502, by receiving an indication of a common communication objective shared by a plurality of wireless nodes (e.g., wireless nodes 402 and 404). For example, the destination node 406 may receive an indication that the wireless nodes 402 and 404 are sensing/measuring the same object, and/or have the same information to convey to destination node. At block 504, a configuration for communicating information (e.g., sensor data) associated with the common communication objective may be determined based on the common communication objective.

In some aspects, the configuration may be determined further based on one or more factors. These factors may include at least one of a proximity between the plurality of wireless nodes (e.g., wireless nodes 402 and 404), a condition of a channel used to communicate the information, traffic conditions on the channel, power limitations of at least one of the plurality of wireless nodes, mobility of at least one of the plurality wireless nodes, coverage preferences, payload size of the information, whether communication is a hybrid automatic repeat request (HARQ) transmission or a HARQ retransmission, or a number of wireless nodes sharing the communication objective. At block 506, the information may be communicated with at least one of the plurality of wireless nodes based on the configuration.

The determination of the communication configuration may involve selecting between a cooperative (e.g., a joint) communication configuration and a non-cooperative (e.g., a single node) communication configuration. For example, for a joint communication configuration, a plurality of wireless nodes, such as wireless nodes 402 and 404, may communicate (e.g., receive and/or transmit) information associated with the common communication objective with the destination node 406, as illustrated via lines 412 and 414. However, when a single node communication configuration is selected, a single wireless node (e.g., wireless node 404) may communicate (e.g., receive and/or transmit) the information to the destination node 406.

In certain aspects, the proximity between the wireless nodes (e.g., wireless nodes 402 and 404) can be measured and used in determining the communication configuration. For example, the determined proximity may be communicated to the destination node 406 and the destination node 406 may determine the configuration based on the determined proximity. In some cases, the wireless nodes 402 and 404 may be scheduled by the destination node 406 via the same control channel, or separate control channels (e.g., separate control channel for each of the wireless nodes).

As presented above, at least one of the wireless nodes 404 and 404 or the destination node 406 may determine whether to use a non-cooperative communication configuration or a cooperative communication configuration. For example, the wireless nodes 402 and 404 may be dynamically indicated or semi-statically indicated by the destination node 406 to select one of the wireless nodes for cooperative communication. In this case, a node-specific identifier (ID) may be explicitly or implicitly indicated in a control channel.

In some cases, a cooperative communication configuration may be selected where at least two wireless nodes (e.g., wireless nodes 402 and 404) are used to communicate the information to the destination node 406. The joint communication of information may be implemented by separate coding/modulation/resource mapping or via joint coding/modulation/resource mapping.

The selection of the cooperation among the wireless nodes 402 and 404 in a particular communication can be performed by the destination node 406 as described above with respect to FIG. 5, or by the wireless node 402 or 404. In some cases, the set of nodes involved in communication can be updated as frequently as on a per subframe basis. Moreover, the selection of the cooperation between the wireless nodes 402 and 404 can be based on, for example, channel conditions, traffic conditions, battery power conditions, mobility, coverage preferences, and/or the number of nodes sharing the same communication objective. For example, under favorable channel conditions, a single node communication configuration may be selected. However, under unfavorable channel conditions, a multi-user diversity communication configuration or a joint communication configuration may be selected.

In some cases, the determination of the communication configuration may be based on a payload size of the information that is being communicated between the wireless nodes 402 and 404 and the destination node 406. For example, when communicating information with large payloads, a joint communication configuration or multi-layer communication configuration may be selected. However, when communicating information with a small payload, a single node communication configuration may be selected.

In some cases, the determination of the configuration may be based on power limitations of the wireless nodes 402 and 404. For example, in cases where maintaining equal battery life among the wireless nodes 402 and 404 is a design criterion, the communication configuration may be selected such that there is equal-involvement of the wireless nodes (long-term or short-term) for communications. However, where some nodes are more power-constrained, the configuration may be selected such that the wireless node(s) that are more power-constrained are less involved.

In some cases, the determination of the communication configuration may be based on a level of mobility associated with the wireless nodes 402 and 404. For example, for high mobility nodes, a higher number of wireless nodes may be selected for involvement in the communication of information with the destination node 406 in order to increase diversity. However, when under large coverage and when channel diversity is unlikely due to low mobility, a single node communication configuration may be selected. In some cases, when there are a large number of wireless nodes that share the same information that is to be conveyed to the destination node 406, a single frequency network (SFN) operation may be selected.

In some cases, different communication configurations (e.g., cooperation schemes) may be selected for the same TB. For example, different communication configurations may be selected for the same TB during hybrid automatic repeat request (HARQ) transmission/retransmission. That is, a single node communication configuration may be selected for a first HARQ transmission, but a joint communication configuration may be selected for HARQ retransmissions. In this case, when communicating information via joint communication, a wireless node (e.g., wireless node 404) may participate in the communication of the information via a store-and-forward or decode-and-forward mechanism.

While wireless nodes 402 and 404 may be directed (e.g., indicated) via a control channel or a side-link channel for non-cooperative or cooperative communication (i.e., single or join communication), this can be generalized to the case of a mesh network where nodes are not directed by any source to perform single node versus cooperative communication, but can form a decision on their own. Each of wireless nodes may be part of a mesh network and may relay data in the mesh network. For example, where there are four wireless nodes (node A, node B, node C, and node D), the wireless nodes may be configured to learn of their surroundings through, for example, channel sounding and/or routing table propagation. Node A may be passing information to node D (e.g., destination node) through one or more other nodes B and C. Each of nodes B and C can form a judgement (e.g., implicitly) as to whether to perform an individual transmission or joint transmission of the information to the destination node (e.g., node D) based upon knowledge of the surrounding nodes/routing table. That is, nodes B and C may not be commanded by node A to send the information to node D but can formulate the decision on their own.

In some cases, channel feedback or measurement may be performed by one or more wireless nodes assuming different transmission schemes involving cooperative and/or non-cooperative transmissions. The channel feedback or measurement may be periodically triggered or aperiodically triggered. Alternatively, channel sounding signals may be transmitted to facilitate channel measurement by the destination node. Additionally or separately, other information may also be reported, e.g., battery power level information of one or more wireless nodes. With the information of channel conditions of various cooperation schemes, along with other information such as battery power level information, an appropriate transmission scheme can be selected.

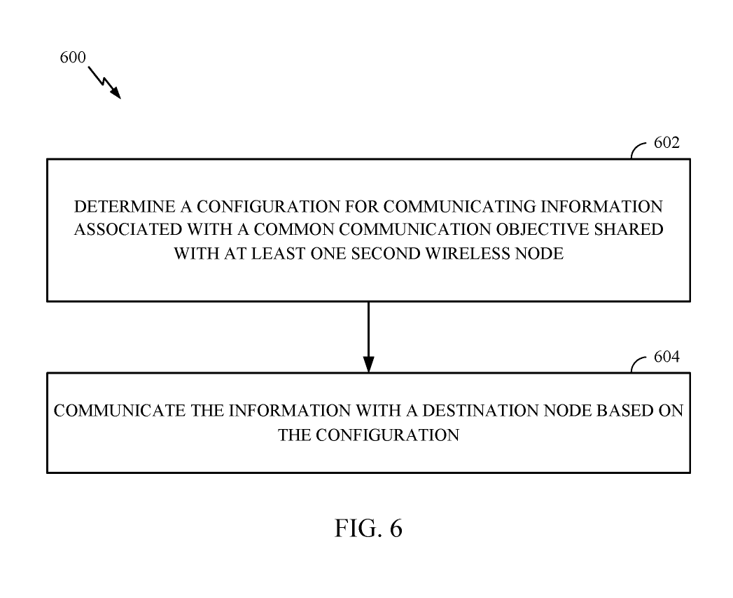

FIG. 6 illustrates example operations 600 for wireless communication, in accordance with certain aspects of the present disclosure. The operations 600 may be performed, for example, by a wireless node (e.g., UE 102).

The operations 600 begin at block 602 by determining a configuration for communicating information associated with a common communication objective shared with at least one second wireless node, and at block 604, communicating the information (e.g., data from sensing the same object, data from measuring the same object, and/or same information to be conveyed to a destination node) with a destination node (e.g., eNodeB 106) based on the configuration. In certain aspects, the communicating involves transmitting an uplink transmission and/or receiving on a downlink transmission.

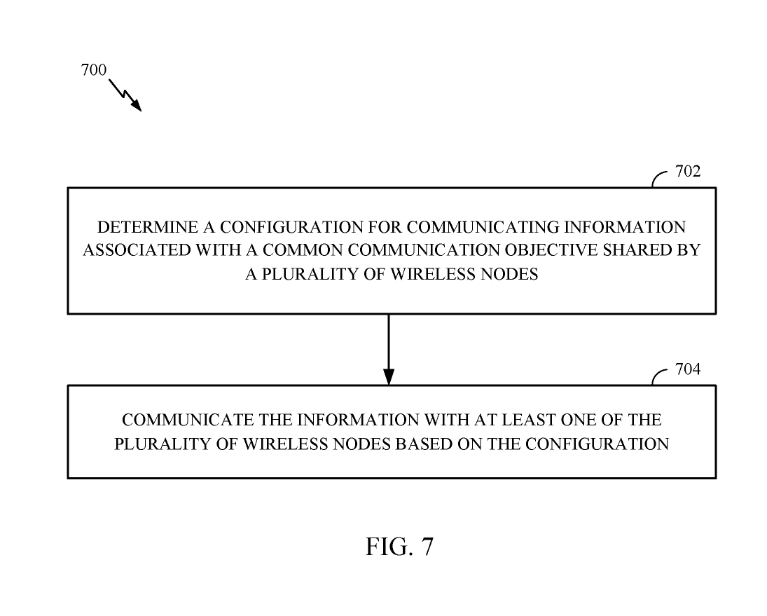

FIG. 7 illustrates example operations 700 for wireless communication, in accordance with certain aspects of the present disclosure. The operations 700 may be performed by a destination node (e.g., eNB 204).

The operations 700 begin at block 702 by determining a configuration for communicating information associated with a common communication objective shared by a plurality of wireless nodes (e.g., UEs 206), and at block 704, communicating the information with at least one of the plurality of wireless nodes based on the configuration. In certain aspects, the communicating involves receiving an uplink transmission and/or transmitting a downlink transmission.

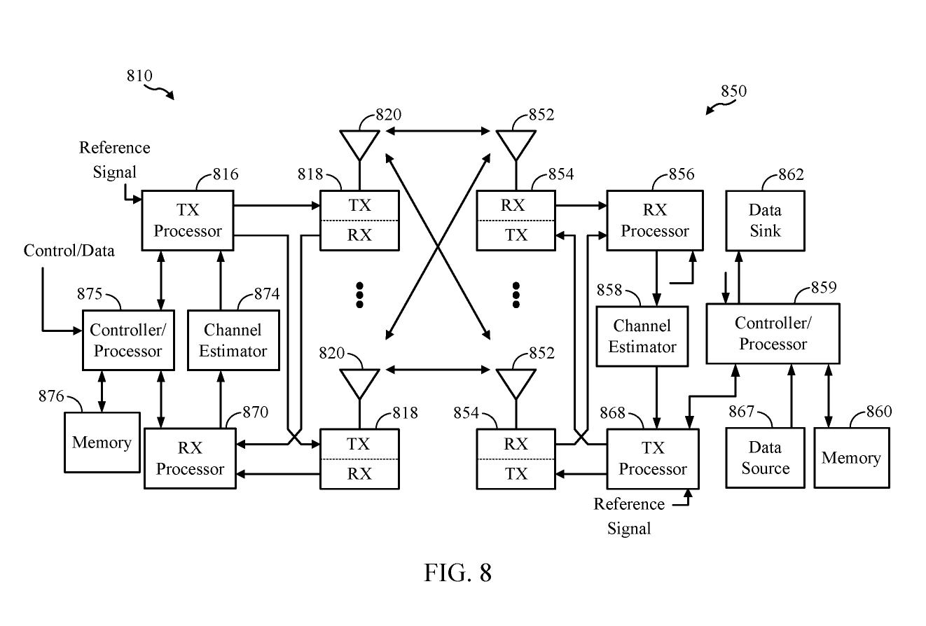

FIG. 8 is a block diagram of an eNB 810 in communication with a UE 850 in an access network, in which aspects of the present disclosure may be practiced.

In certain aspects, a UE (e.g., UE 850) combines pairs of antenna ports to generate at least first and second combined antenna ports. For each combined port, the UE adds reference signals received on Resource Elements (REs) of each of the combined pair of antenna ports. The UE then determines channel estimates for each combined antenna port based on the added reference signals for the combined port. In certain aspects, for each of the combined ports, the UE processes data received on data REs in pairs, based on the determined channel estimates of the combined port.

In certain aspects, a base station (BS) (e.g., eNB 810) combines pairs of antenna ports to generate the at least first and second combined antenna ports, for transmission in a narrow band region of a larger system bandwidth. For each of the first and the second combined antenna ports, the BS transmits same data on corresponding REs of each of the combined pairs of antenna ports, wherein a receiving UE determines channel estimates for each of the first and second combined ports, and processes the data received in the REs in pairs based on the determined channel estimates.

It may be noted that the UE noted above for implementing the new transmission scheme for NB IoT in accordance with certain aspects of the present disclosure may be implemented by a combination of one or more of the controller 859, the RX processor 856, the channel estimator 858 and/or transceiver 854 at the UE 850, for example. Further, the BS may be implemented by a combination of one or more of the controller 875, the TX processor and/or the transceiver 818 at the eNB 810.

In the DL, upper layer packets from the core network are provided to a controller/processor 875. The controller/processor 875 implements the functionality of the L2 layer. In the DL, the controller/processor 875 provides header compression, ciphering, packet segmentation and reordering, multiplexing between logical and transport channels, and radio resource allocations to the UE 850 based on various priority metrics. The controller/processor 875 is also responsible for HARQ operations, retransmission of lost packets, and signaling to the UE 850.

The TX processor 816 implements various signal processing functions for the L1 layer (i.e., physical layer). The signal processing functions includes coding and interleaving to facilitate forward error correction (FEC) at the UE 850 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 874 may be used to determine the coding and modulation scheme, as well as for spatial processing. The channel estimate may be derived from a reference signal and/or channel condition feedback transmitted by the UE 850. Each spatial stream is then provided to a different antenna 820 via a separate transmitter 818. Each transmitter 818 modulates an RF carrier with a respective spatial stream for transmission.

At the UE 850, each receiver 854RX receives a signal through its respective antenna 852. Each receiver 854RX recovers information modulated onto an RF carrier and provides the information to the receiver (RX) processor 856. The RX processor 856 implements various signal processing functions of the L1 layer. The RX processor 856 performs spatial processing on the information to recover any spatial streams destined for the UE 850. If multiple spatial streams are destined for the UE 850, they may be combined by the RX processor 856 into a single OFDM symbol stream. The RX processor 856 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 810. These soft decisions may be based on channel estimates computed by the channel estimator 858. The soft decisions are then decoded and deinterleaved to recover the data and control signals that were originally transmitted by the eNB 810 on the physical channel. The data and control signals are then provided to the controller/processor 859.

The controller/processor 859 implements the L2 layer. The controller/processor can be associated with a memory 860 that stores program codes and data. The memory 860 may be referred to as a computer-readable medium. In the UL, the controller/processor 859 provides demultiplexing between transport and logical channels, packet reassembly, deciphering, header decompression, control signal processing to recover upper layer packets from the core network. The upper layer packets are then provided to a data sink 862, which represents all the protocol layers above the L2 layer. Various control signals may also be provided to the data sink 862 for L3 processing. The controller/processor 859 is also responsible for error detection using an acknowledgement (ACK) and/or negative acknowledgement (NACK) protocol to support HARQ operations.

In the UL, a data source 867 is used to provide upper layer packets to the controller/processor 859. The data source 867 represents all protocol layers above the L2 layer. Similar to the functionality described in connection with the DL transmission by the eNB 810, the controller/processor 859 implements the L2 layer for the user plane and the control plane by providing header compression, ciphering, packet segmentation and reordering, and multiplexing between logical and transport channels based on radio resource allocations by the eNB 810. The controller/processor 859 is also responsible for HARQ operations, retransmission of lost packets, and signaling to the eNB 810.

Channel estimates derived by a channel estimator 858 from a reference signal or feedback transmitted by the eNB 810 may be used by the TX processor 868 to select the appropriate coding and modulation schemes, and to facilitate spatial processing. The spatial streams generated by the TX processor 868 are provided to different antenna 852 via separate transmitters 854. Each transmitter 854 modulates an RF carrier with a respective spatial stream for transmission.

The UL transmission is processed at the eNB 810 in a manner similar to that described in connection with the receiver function at the UE 850. Each receiver 818RX receives a signal through its respective antenna 820. Each receiver 818RX recovers information modulated onto an RF carrier and provides the information to a RX processor 870. The RX processor 870 may implement the L1 layer.

The controller/processor 875 implements the L2 layer. The controller/processor 875 can be associated with a memory 876 that stores program codes and data. The memory 876 may be referred to as a computer-readable medium. In the UL, the controller/processor 875 provides demultiplexing between transport and logical channels, packet reassembly, deciphering, header decompression, control signal processing to recover upper layer packets from the UE 850. Upper layer packets from the controller/processor 875 may be provided to the core network. The controller/processor 875 is also responsible for error detection using an ACK and/or NACK protocol to support HARQ operations. The controllers/processors 875, 859 may direct the operations at the eNB 810 and the UE 850, respectively.

The controller/processor 859 and/or other processors, components and/or modules at the UE 850 may perform or direct operations, for example, operations 600 in FIG. 6, and/or other processes for the techniques described herein for implementing the new transmission scheme. Further, the controller/processor 875 and/or other processors, components and/or modules at the eNB 810 may perform or direct operations, for example, operations 700 in FIG. 7, and/or other processes for the techniques described herein for implementing the new transmission scheme. In certain aspects, one or more of any of the components shown in FIG. 8 may be employed to perform example operations 600 and 700, and/or other processes for the techniques described herein. The memories 860 and 876 may store data and program codes for the UE 850 and eNB 810 respectively, accessible and executable by one or more other components of the UE 850 and the eNB 810. While blocks in FIG. 8 are illustrated as distinct components, the functions described above with respect to the blocks may be implemented in a single hardware, software, or combination of hardware and software component, or in various combinations of components.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for determining, means for indicating, and/or means for including, may comprise a processing system, which may include one or more processors, such as the TX processor 816, transmitter(s) 818, and/or the controller/processor 875 of the eNB 810 illustrated in FIG. 8, and/or the TX processor 868, the transmitter(s) 854, and/or the controller/processor 859 of the user equipment 850 illustrated in FIG. 8. Means for transmitting and/or means for sending may comprise a transmitter, which may include TX processor 816, transmitter(s) 818, and/or the antenna(s) 820 of the eNB 810 illustrated in FIG. 8, and/or the TX processor 868, the transmitter(s) 854, and/or the antenna(s) 852 of the user equipment 850 illustrated in FIG. 8. Means for receiving may comprise a receiver, which may include RX processor 870, receiver(s) 818, and/or the antenna(s) 820 of the eNB 810 illustrated in FIG. 8, and/or the RX processor 856, the receiver(s) 854, and/or the antenna(s) 852 of the user equipment 850 illustrated in FIG. 8.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a wireless node (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, phase change memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein.

Further, it should be appreciated that modules and/or other appropriate means for performing the methods and techniques described herein can be downloaded and/or otherwise obtained by a wireless node and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a wireless node and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communication by a first wireless node, comprising:
determining a configuration for communicating information associated with a common communication objective shared with at least one second wireless node; and
communicating the information with a destination node based on the configuration.

2. The method of claim 1, wherein the common communication objective is associated with at least one of sensing the same object, measuring the same object, or having the same information to convey to the destination node.

3. The method of claim 1, further comprising identifying the association with the common communication objective based on at least one of an indication from the destination node, a configuration of the first wireless node and the at least one second wireless node, or an opportunistic assistance from the at least one second wireless node.

4. The method of claim 1, wherein the determining comprises determining whether to use a cooperative communication configuration or a non-cooperative communication configuration.

5. The method of claim 1, further comprising:
transmitting a first indication of the common communication objective to the destination node; and
receiving a second indication of the configuration from the destination node in response to the first indication, wherein the determination of the configured is based on the second indication.

6. The method of claim 1, further comprising determining proximity between the first wireless node and the second wireless node, wherein the configuration is determined based on the proximity.

7. The method of claim 1, wherein the configuration is determined based on at least one of:
a power limitation of at least one of the first wireless node or the second wireless node;
a condition of a channel used to communicate the information; or
a payload size of the information.

8. The method of claim 1, wherein:
the determination of the configuration comprises:
determining to use cooperative communication by the first wireless node and the second wireless node to communicate the information; and
determining how many wireless nodes of the at least one second wireless node are to be involved in the cooperative communication of the information with the destination node.

9. The method of claim 1, wherein the configuration is determined based on a number of wireless nodes sharing the common communication objective.

10. The method of claim 1, wherein the configuration is determined based on a level of mobility associated with the first wireless node.

11. The method of claim 1, wherein the configuration comprise a non-cooperative communication configuration for a first transmission of the information, and a cooperative communication configuration for a subsequent re-transmission of the information.

12. The method of claim 1, wherein the first wireless node and the second wireless node share a common radio-network temporary identifier (RNTI).

13. A method for wireless communication by a destination node, comprising:
determining a configuration for communicating information associated with a common communication objective shared by a plurality of wireless nodes; and
communicating the information with at least one of the plurality of wireless nodes based on the configuration.

14. The method of claim 13, wherein the common communication objective is associated with at least one of sensing the same object, measuring the same object, or having the same information to convey to the destination node.

15. The method of claim 13, further comprising transmitting an indication of the common communication objective to at least one of the plurality of wireless nodes.

16. The method of claim 13, wherein the association of the common communication objective is identified by at least one of a configuration for the plurality of wireless nodes, or an opportunistic assistance from at least one of the wireless nodes.

17. The method of claim 13, wherein the determining comprises determining whether to use a cooperative communication configuration or a non-cooperative communication configuration.

18. The method of claim 13, further comprising receiving an indication of the configuration from at least one of the plurality of wireless nodes, wherein the determination of the configuration is based on the indication.

19. The method of claim 13, further comprising receiving an indication of the common communication objective from at least one of plurality of wireless nodes, wherein the determination of the configuration is based on the indication.

20. The method of claim 13, further comprising transmitting an indication of the configuration to at least one of the plurality of wireless nodes.

21. The method of claim 13, further comprising determining proximity between the plurality of wireless nodes, wherein the configuration is determined based on the proximity.

22. The method of claim 13, wherein the configuration is determined based on at least one of:
a power limitation of at least one of the plurality of wireless nodes;
a condition of a channel used to communicate the information; or
a payload size of the information.

23. The method of claim 13, wherein the determination of the configuration comprises determining how many wireless nodes of the plurality of wireless nodes are to be involved in cooperative communication of the information with the destination node.

24. The method of claim 13, wherein the configuration is determined based on how many wireless nodes of the plurality of wireless nodes share the common communication objective.

25. The method of claim 13, wherein the configuration is determined based on a level of mobility associated with at least one of the plurality of wireless nodes.

26. The method of claim 13, wherein the configuration comprise a non-cooperative communication configuration for a first transmission of the information, and a cooperative communication configuration for a subsequent re-transmission of the information.

27. The method of claim 13, wherein the communication of the information comprises communicating the information to a first wireless node of the plurality of wireless nodes through a second wireless node of the plurality of wireless nodes.

28. The method of claim 13, wherein the plurality of wireless nodes share a common radio-network temporary identifier (RNTI).

29. An apparatus for wireless communication by a first wireless node, comprising:
at least one antenna;
a processing system configured to:
determine a configuration for communicating information associated with a common communication objective shared with at least one second wireless node; and
communicate, via the at least one antenna, the information with a destination node based on the configuration.

30. An apparatus for wireless communication by a destination node, comprising:
at least one antenna;
a processing system configured to:
determine a configuration for communicating information associated with a common communication objective shared by a plurality of wireless nodes; and
communicate, via the at least one antenna, the information with at least one of the plurality of wireless nodes based on the configuration.
